(19) United States
(12) Patent Application Publication
(10) Pub. No.: US 2025/0076781 A1
(43) Pub. Date: Mar. 6, 2025

(54) OPTICAL SCANNING DEVICE AND IMAGE FORMING DEVICE

(71) Applicant: SHARP KABUSHIKI KAISHA, Sakai City (JP)

(72) Inventors: Hidenori SATO, Sakai City (JP); KENZO OHKUBO, Sakai City (JP); ATSUO NAKAO, Sakai City (JP); HIROSHI YAMAMOTO, Sakai City (JP); TAKAHARU MOTOYAMA, Sakai City (JP)

(21) Appl. No.: 18/799,111

(22) Filed: Aug. 9, 2024

(30) Foreign Application Priority Data
Aug. 28, 2023 (JP) 2023-137798

(51) Int. Cl. G03G 15/043; B41J 2/447; B41J 2/47; G02B 26/12; G03G 15/04

(52) U.S. Cl. CPC G03G 15/0435; B41J 2/447; B41J 2/471; G02B 26/123; G03G 15/04036; G03G 15/0409

(57) ABSTRACT

An optical scanning device includes a first expander lens that expands beams emitted from a plurality of laser diodes in a main scanning direction. The beams emitted from the plurality of laser diodes are incident on the first expander lens, the first expander lens being a single lens. The plurality of laser diodes are disposed with optical paths of the beams from the plurality of light sources to a polygon mirror (rotary polygon mirror) overlapping each other in the main scanning direction when viewed from a direction along a rotary shaft of the polygon mirror.

### CROSS-REFERENCE TO RELATED APPLICATION

The present application claims priority from Japanese Application JP 2023-137798, the content to which is hereby incorporated by reference into this application.

### BACKGROUND OF THE INVENTION

### 1. Field of the Invention

The disclosure relates to an optical scanning device and an image forming device that cause beams emitted from a plurality of light sources to be incident on a polygon mirror.

### 2. Description of the Related Art

In image forming devices such as digital copiers, laser printers, or facsimiles, optical scanning devices that scan laser beams have been used. When an image is formed by an image forming device, after a photoreceptor is charged by a charging device, writing is performed according to image information by the optical scanning device, forming an electrostatic latent image on the photoreceptor. Then, the electrostatic latent image on the photoreceptor is developed by toner supplied from a development device. The toner image developed on the photoreceptor is transferred onto a sheet by a transfer device, and further fixed onto the sheet by a fixing device, whereby a desired image is obtained.

Laser diodes that serve as light sources for the optical scanning device are arranged close together in a height direction and disposed side by side in an inclined manner.

### SUMMARY

In optical scanning devices in the related art, in order to arrange the laser diodes close to each other in the height direction in consideration of optical performance such as a beam size, the plurality of laser diodes are arranged obliquely side by side. Positions of the plurality of laser diodes are thus shifted with respect to a main scanning direction of the optical scanning device, causing the optical paths to differ from each other and, as a result, there is the problem that a plurality of return mirrors, lenses, and the like are required.

The disclosure has been made to solve the above-described problems, and an object of the disclosure is to provide an optical scanning device and an image forming device capable of equally arranging optical path lengths from respective light sources to a rotary polygon mirror.

An optical scanning device according to an aspect of the disclosure is an optical scanning device that causes beams emitted from a plurality of light sources to be incident on a rotary polygon mirror. The optical scanning device includes a first expander lens that expands the beams emitted from the plurality of light sources in a main scanning direction. The beams emitted from the plurality of light sources are incident on the first expander lens, the first expander lens being a single lens. The plurality of light sources are disposed with optical paths of the beams from the plurality of light sources to the rotary polygon mirror overlapping each other in the main scanning direction when viewed from a direction along a rotary shaft of the rotary polygon mirror.

In the optical scanning device according to an aspect of the disclosure, a configuration may be adopted in which the plurality of light sources are linearly disposed in a sub-scanning direction orthogonal to the main scanning direction.

In the optical scanning device according to an aspect of the disclosure, a configuration may be adopted in which the optical scanning device includes a cylindrical lens that changes an incident angle with respect to the rotary polygon mirror in a sub-scanning direction orthogonal to the main scanning direction.

In the optical scanning device according to an aspect of the disclosure, a configuration may be adopted in which the cylindrical lens is integrated with the first expander lens.

In the optical scanning device according to an aspect of the disclosure, a configuration may be adopted in which the plurality of light sources are disposed with the incident angle of each of the beams emitted from the plurality of light sources on the rotary polygon mirror being asymmetric in the sub-scanning direction.

In the optical scanning device according to an aspect of the disclosure, a configuration may be adopted in which a second expander lens that collimates beams is disposed in an area from the first expander lens to the rotary polygon mirror in an optical path from the plurality of light sources to the rotary polygon mirror.

In the optical scanning device according to an aspect of the disclosure, a configuration may be adopted in which the optical scanning device includes a housing to which the plurality of light sources are attached, and the housing includes openings that narrow the beams emitted from the plurality of light sources.

An image forming device according to an aspect of the disclosure is an image forming device including the optical scanning device according to the disclosure.

According to an aspect of the disclosure, optical path lengths from each light source to a rotary polygonal mirror are equal and focal points align, making it possible simply include a single first expander lens, facilitating space-saving and reducing cost.

### BRIEF DESCRIPTION OF THE DRAWINGS

FIG. 1 is a schematic side view of an image forming device according to an embodiment of the disclosure.

FIG. 2 is a perspective view illustrating an optical scanning device according to an embodiment of the disclosure.

FIG. 3 is a plan view illustrating the optical scanning device according to the embodiment of the disclosure.

FIG. 4 is an enlarged side view illustrating attachment locations of laser diodes in a housing, in an enlarged manner.

FIG. 5 is an enlarged perspective view illustrating an aperture formation area and the vicinity thereof.

FIG. 6 is an enlarged cross-sectional view illustrating the aperture formation area and the vicinity thereof as viewed from the front.

FIG. 7 is a schematic perspective view illustrating a positional relationship of optical components in the optical scanning device.

FIG. 8 is a schematic plan view illustrating the positional relationship of optical components in the optical scanning device.

FIG. 9 is a schematic explanatory view illustrating part of an optical path of a beam in a main scanning direction.

FIG. 10 is a schematic explanatory view illustrating part of the optical path of the beam in a sub-scanning direction.

### DETAILED DESCRIPTION OF THE INVENTION

An image forming device according to an embodiment of the disclosure will be described below with reference to the accompanying drawings.

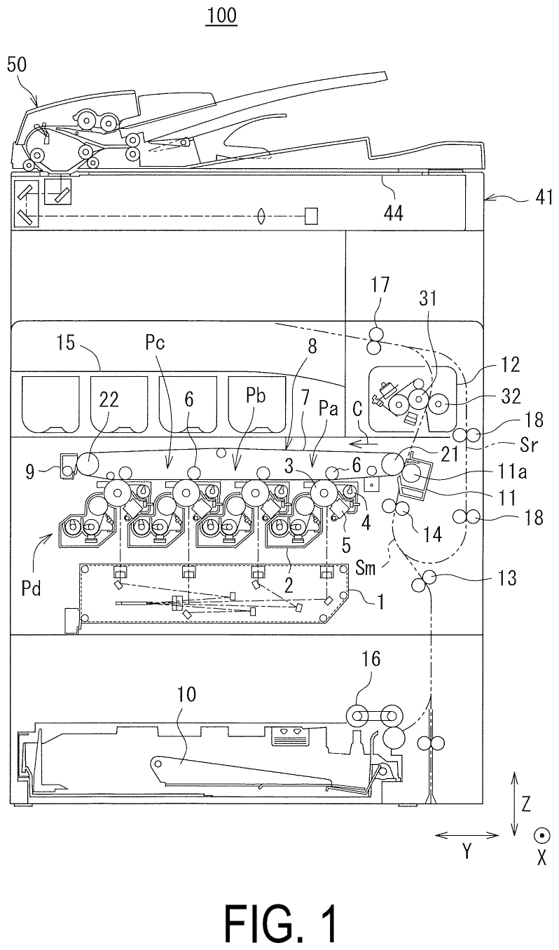

FIG. 1 is a schematic side view of an image forming device according to an embodiment of the disclosure.

An image forming device 100 is a multifunction printer having a scanner function, a copy function, a printer function, and a facsimile function, and transmits an image of a document scanned by an image scanning device to an external device (corresponding to the scanner function), forming an image of a scanned document or an image received from an external device on a sheet in color or black and white (corresponding to the copy function, the printer function, and the facsimile function).

A document feeding device 50 (automatic document feeder (ADF)) supported in an openable/closable manner by an image scanner 41 is provided on an upper side of the image scanner 41. When the document feeding device 50 is opened, a document table 44 upward of the image scanner 41 is opened, and a document can be manually placed thereon. Further, the document feeding device 50 automatically feeds a placed document onto the image scanner 41. The image scanner 41 scans the placed document or a document fed from the document feeding device 50 to generate image data.

The image forming device 100 includes an optical scanning device 1, a development device 2, a photoreceptor drum 3, a drum cleaning device 4, a charger 5, an intermediate transfer belt 7, a fixing device 12, a sheet conveying path Sm, a sheet feeding cassette 10, a stacking tray 15, and the like.

The image forming device 100 handles image data corresponding to a color image composed of the colors black (K), cyan (C), magenta (M), and yellow (Y), or a monochrome image composed of a single color (black, for example). The image forming device 100 is provided with four sets of the development device 2, four sets of the photoreceptor drum 3, four sets of the drum cleaning device 4, and four sets of the charger 5 that form four types of toner images, with the sets respectively serving as image stations Pa, Pb, Pc, Pd corresponding to the colors black, cyan, magenta, and yellow, respectively.

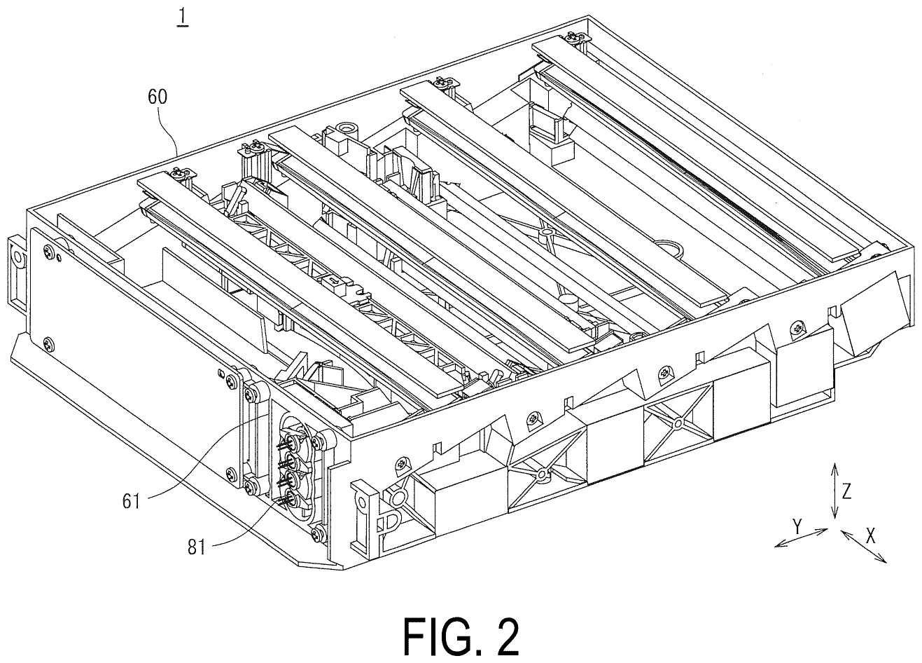

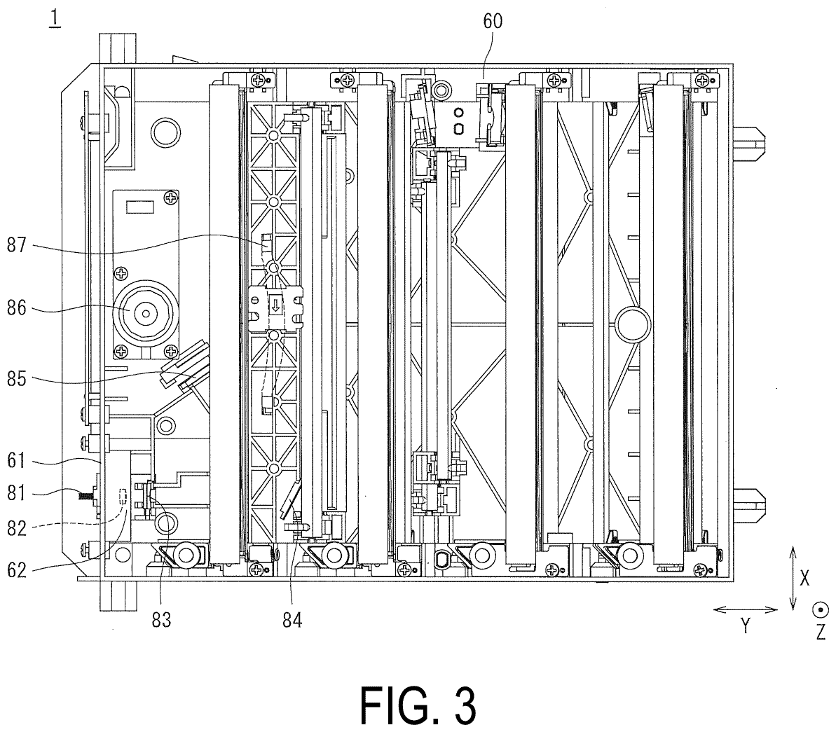

The drum cleaning device 4 removes and collects residual toner on a front surface of the photoreceptor drum 3. The charger 5 uniformly charges the front surface of the photoreceptor drum 3 to a predetermined potential. The optical scanning device 1 exposes the front surface of the photoreceptor drum 3 to form an electrostatic latent image. The development device 2 develops the electrostatic latent image on the front surface of the photoreceptor drum 3 to form a toner image on the front surface of the photoreceptor drum 3. With this series of operations, a toner image of each color is formed on the front surface of each photoreceptor drum 3. Note that a detailed structure of the optical scanning device 1 will be described with reference to FIG. 2 and FIG. 3 described below.

At an upper side of the photoreceptor drums 3, a transfer belt device 8 is provided and intermediate transfer rollers 6 are disposed with the intermediate transfer belt 7 being interposed therebetween. The intermediate transfer belt 7 is stretched over a transfer drive roller 21 and a transfer driven roller 22 and rotated in the direction of an arrow C, the residual toner is removed and collected by a belt cleaning device 9, and the toner images of respective colors formed on the respective surfaces of the photoreceptor drums 3 are sequentially transferred and superimposed to form a color toner image on a front surface of the intermediate transfer belt 7.

A transfer roller 11a of a second transfer device 11 forms a nip region with the intermediate transfer belt 7, and a sheet fed through the sheet conveying path Sm is fed while being nipped in the nip region. When the sheet passes through the nip region, a toner image on the front surface of the intermediate transfer belt 7 is transferred to the sheet, and the sheet is conveyed to the fixing device 12.

The fixing device 12 includes a fixing roller 31 and a pressure roller 32 that sandwich the sheet and rotate. In the fixing device 12, the sheet with the transferred toner image is nipped between the fixing roller 31 and the pressure roller 32 and subject to heat and pressure to fix the toner image onto the sheet.

The sheet feeding cassette 10 is a cassette for storing the sheets to be used for image formation, and is provided below the optical scanning device 1. The sheet is pulled out from the sheet feeding cassette 10 by a sheet pickup roller 16 and is conveyed through the sheet conveying path Sm. Then, the sheet passes through the second transfer device 11 and the fixing device 12, and is conveyed through a sheet discharge roller 17 to the stacking tray 15. Along the sheet conveying path Sm, there are disposed sheet registration rollers 14 that temporarily stop the sheet to align a leading edge of the sheet and then start conveying the sheet in sync with a transfer timing of a color toner image at the nip region between the intermediate transfer belt 7 and the transfer roller 11a; conveying rollers 13 that facilitate the conveying of the sheet; and sheet discharge rollers 17.

Further, when an image is formed on both a front surface and a back surface of the sheet, the sheet is conveyed in the reverse direction from the discharge rollers 17 onto a sheet reverse path Sr. In the sheet reverse path Sr, the front and back of the sheet are reversed through reversing rollers 18, and the sheet is led again to the sheet registration rollers 14. Subsequently, an image is formed on the back surface in the same manner as the front surface, and the sheet is discharged to the stacking tray 15.

FIG. 2 is a perspective view illustrating the optical scanning device according to the embodiment of the disclosure, and FIG. 3 is a plan view illustrating the optical scanning device according to the embodiment of the disclosure.

The optical scanning device 1 according to the embodiment of the disclosure includes a housing 60 having a rectangular shape, and optical components are attached to respective areas of the housing 60. Note that FIG. 2 and FIG. 3 illustrate a state in which some members such as an upper surface of the housing 60 are removed, making an interior of the housing 60 visible for ease of viewing of the drawings. Hereinafter, for the sake of description, a direction along one side surface (for example, attachment side surface 61) of the housing 60 may be referred to as a width direction X, a direction along a side surface adjacent to the attachment side surface 61 may be referred to as a length direction Y, and a direction orthogonal to the width direction X and the length direction Y may be referred to as a height direction Z. The width direction X described above is also a main scanning direction S of the optical scanning device 1, the length direction Y is also a direction in which the beams are emitted from the light sources, and the height direction Z is also a sub-scanning direction H of the optical scanning device 1.

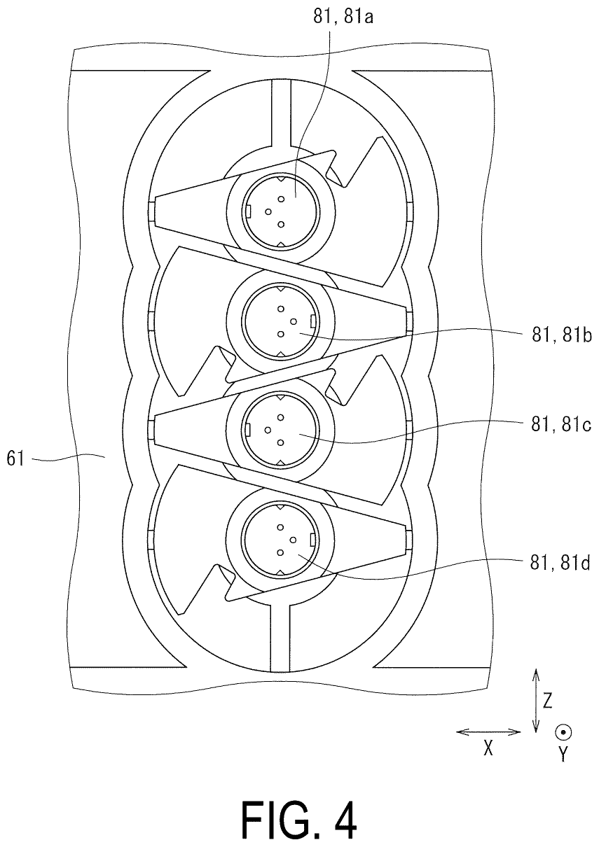

FIG. 4 is an enlarged side view illustrating attachment locations of laser diodes in the housing, in an enlarged manner.

A plurality of laser diodes 81 (example of light sources) are attached to the attachment side surface 61 of the housing 60. In FIG. 4, the vicinity of the attachment locations of the laser diodes 81 on the attachment side surface 61 of the housing 60 is illustrated in an enlarged manner. In the present embodiment, four laser diodes 81 are attached to the housing 60. The four laser diodes 81 (first diode 81a to the fourth diode 81d) are disposed aligned on a straight line in the height direction Z.

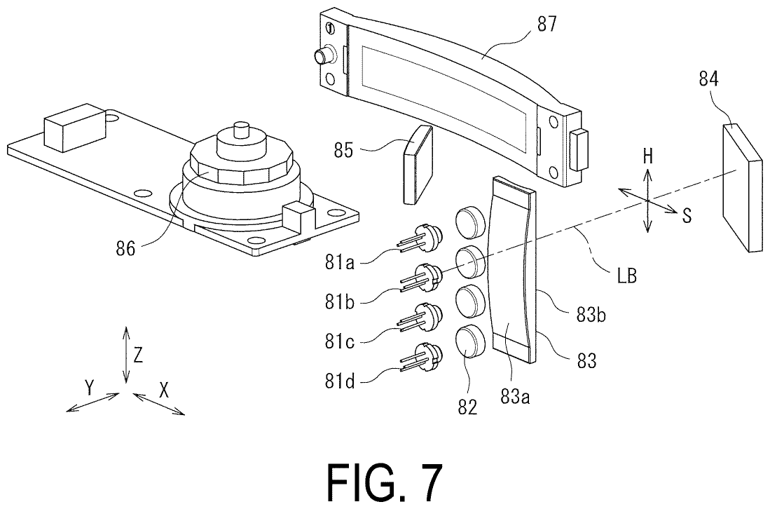

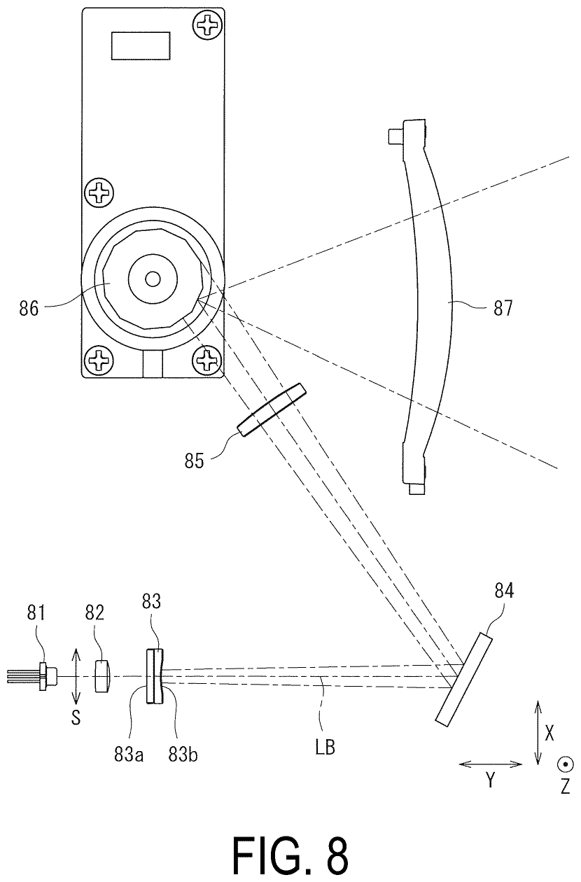

In addition to the laser diodes 81, optical components such as a collimator lens 82, integrated lenses 83 (cylindrical lens 83a and first expander lens 83b), a reflection mirror 84, a second expander lens 85, a polygon mirror 86 (rotary polygon mirror), and an fθ lens 87 are attached to the housing 60. Note that the components attached to the housing 60 are not limited thereto, and various components such as mirrors, lenses, and sensors may be attached. A relationship between beams LB emitted from the laser diodes 81 and the optical components will now be described with reference to FIG. 7 and FIG. 8 described below.

An aperture formation area 62 is provided in the vicinity of an attachment area of the collimator lens 82 in the housing 60.

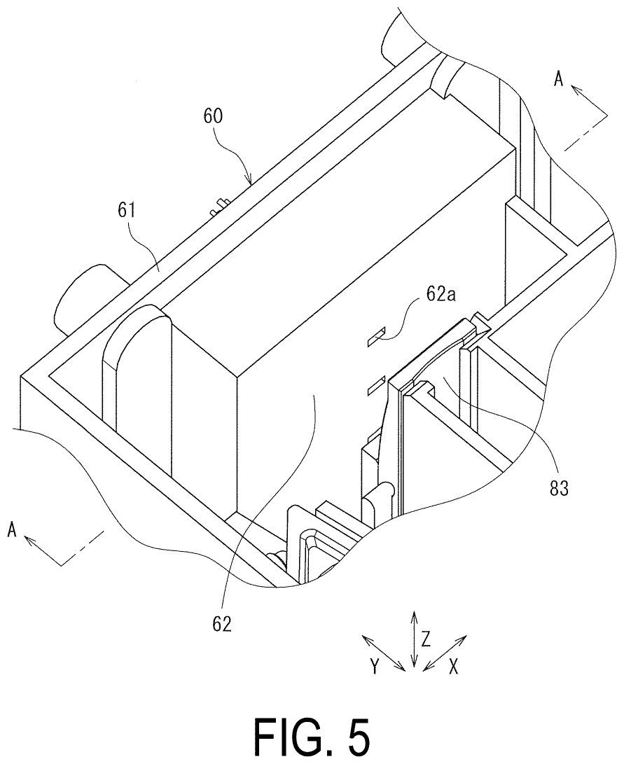

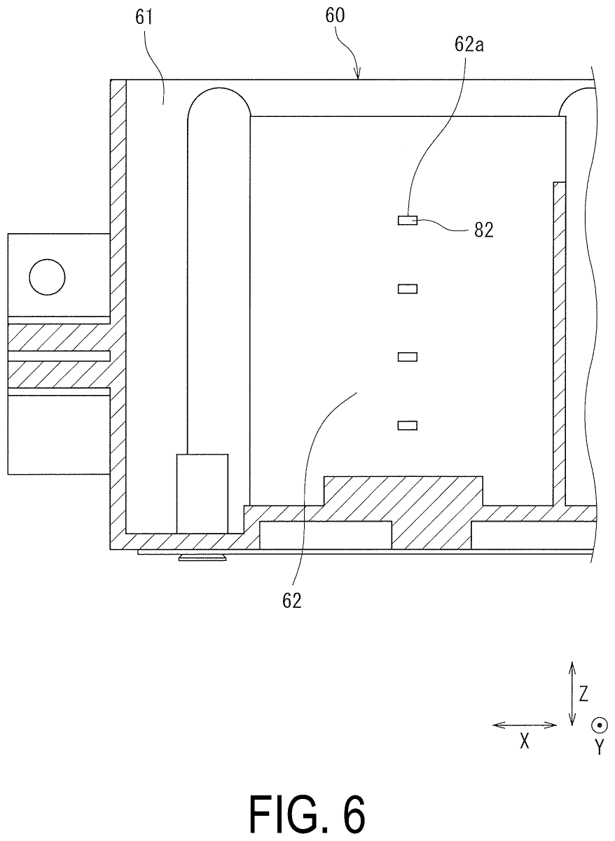

FIG. 5 is an enlarged perspective view illustrating the vicinity of the aperture formation area, and FIG. 6 is an enlarged cross-sectional view taken along arrow A-A in FIG. 5 and illustrating the vicinity of the aperture formation area.

The aperture formation area 62 is a wall surface that blocks an area between the collimator lens 82 and the integrated lens 83. The aperture formation area 62 is provided with apertures 62a (openings) obtained by opening areas facing the collimator lens 82. The apertures 62a have a function of narrowing beams emitted from the four laser diodes 81 (first diode 81a to fourth diode 81d). When a beam emitted from the collimator lens 82 passes through the aperture 62a, the beam is shaped into a shape corresponding to that of the aperture 62a. Thus, by providing the apertures 62a in the housing 60 itself, it is possible to eliminate the space for attachment of the apertures 62a. A provided quantity and positions of the apertures 62a may be adjusted in accordance with the laser diodes 81.

FIG. 7 is a schematic perspective view illustrating a positional relationship of optical components in the optical scanning device, and FIG. 8 is a schematic plan view illustrating the positional relationship of optical components in the optical scanning device. Note that, in FIG. 7 and FIG. 8, some of the optical components in the optical scanning device 1 are removed in consideration of case of viewing of the drawings.

As described above, the optical components, such as the laser diodes 81 (first diode 81a to fourth diode 81d), the collimator lens 82, the integrated lens 83, the reflection mirror 84, the second expander lens 85, the polygon mirror 86, and the fθ lens 87, are attached to the housing 60 of the optical scanning device 1.

In FIG. 7, a portion of the beams LB emitted from the laser diodes 81 (in particular, the second diode 81b) is indicated by an alternate long and short dash line. Note that, although omitted in FIG. 7, the beams LB are emitted from the laser diodes 81 other than the second diode 81b in the same way. The main scanning direction S and the sub-scanning direction H imparted to the beam LB are directions in which the beams LB are scanned and correspond to directions in which the light expands. In the optical paths of the beams LB from the laser diodes 81 to the reflection mirror 84, the main scanning direction S is parallel to the width direction X, and the sub-scanning direction H is parallel to the height direction Z. Hereinafter, for the sake of description, of the optical paths of the beams LB, a portion from the laser diode 81 to the polygon mirror 86 may be referred to as an incidence system, and a portion from the polygon mirror 86 to a surface to be scanned (for example, the photosensitive drum 3) may be referred to as an emission system.

Four collimator lenses 82 are provided in correspondence with the four laser diodes 81, and are disposed in the optical paths of the beams LB emitted from the laser diodes 81.

The integrated lens 83 is disposed in the optical paths of the beams LB emitted from the collimator lenses 82. In the present embodiment, one integrated lens 83 is provided for the four laser diodes 81. Specifically, the integrated lens 83 is a vertically long lens that is long in the height direction Z in accordance with the four laser diodes 81 disposed aligned in the height direction Z (sub-scanning direction H), and all beams LB emitted from the four laser diodes 81 are incident thereon.

In the present embodiment, the integrated lens 83 is a lens having curvatures with respect to different directions on the incident surface and the emission surface. By integrating the two lenses (cylindrical lens 83a and first expander lens 83b) in this manner, it is possible to reduce the size of the device.

Specifically, the incident surface of the integrated lens 83 is the cylindrical lens 83a and acts to narrow the incident beams LB in the sub-scanning direction H. Furthermore, the cylindrical lens 83a adjusts the direction (irradiation angle) in which the beams LB passing therethrough are emitted in the sub-scanning direction H. The four beams LB passed through the cylindrical lens 83a change in exiting directions, converging with each other in the sub-scanning direction H. When the four beams LB reach the polygon mirror 86, the beams LB are most converged in the sub-scanning direction H and, after passing through the polygon mirror 86, the beams LB are diffused in the sub-scanning direction H.

An exit surface of the integrated lens 83 is the first expander lens 83b, which acts on the beams LB incident thereon, expanding an irradiation range in the main scanning direction S (width direction X).

In the present embodiment, the integrated lens 83 in which the cylindrical lens 83a and the first expander lens 83b are integrated is used. However, the configuration is not limited thereto, and the two lenses may be provided independently. In this case as well, the cylindrical lens 83a may be disposed upstream and the first expander lens 83b may be disposed downstream in the optical paths of the beams LB.

The reflection mirror 84 is disposed in the optical paths of the beams LB emitted from the integrated lens 83, and guides the reflected beams LB, causing the beams LB to be incident on the polygon mirror 86 through the curved lens 85.

The second expander lens 85 is disposed in the optical path from the reflection mirror 84 to the polygon mirror 86, and acts on the incident beams LB, narrowing the irradiation range in the main scanning direction S. The second expander lens 85 has a radius of curvature corresponding to that of the first expander lens 83b and collimates the incident beams LB. That is, the irradiation range of the beams LB having passed through the second expander lens 85 does not change in the main scanning direction S.

The polygon mirror 86 is, for example, a polygon mirror having a plurality of surfaces and a rotary shaft rotated by a driver such as a motor, and reflects the incident beams LB while rotating, causing the beams LB to scan the front surfaces of the photosensitive drums 3.

The fθ lens 87 is provided at a position facing the polygon mirror 86, and the beams LB emitted from the polygon mirror 86 are incident thereon. Although not illustrated, optical components, such as a lens and a mirror, may be provided in the optical path ahead of the fθ lens 87, and the beams LB may scan the front surfaces of the photosensitive drums 3 via these components.

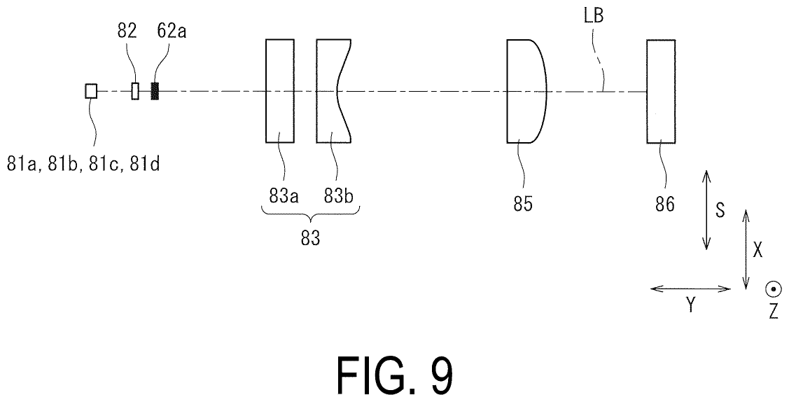

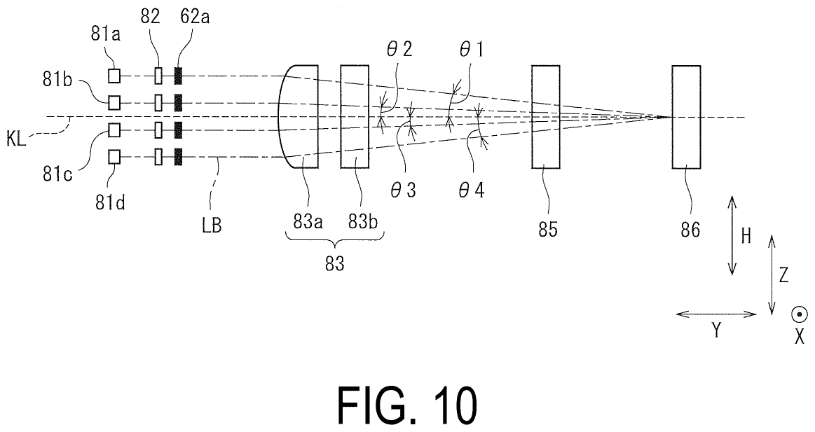

Next, the behavior of the beams LB in the optical path of the incidence system will be described with reference to FIG. 9 and FIG. 10.

FIG. 9 is a schematic explanatory view illustrating part of the optical paths of the beams in the main scanning direction S, and FIG. 10 is a schematic explanatory view illustrating part of the optical paths of the beams in the sub-scanning direction H. Note that the reflection mirror 84 does not affect an optical path length or the irradiation range of the beams LB, and thus is omitted.

FIG. 9 illustrates a state viewed from a direction along the rotary shaft of the polygon mirror 86. As illustrated in FIG. 9, the plurality of laser diodes 81 are disposed with the optical paths of the respective beams from the plurality of laser diodes 81 to the polygon mirror 86 overlapping in the main scanning direction S. In such a configuration, the optical path lengths from the respective laser diodes 81 to the polygon mirror 86 are equal and the focal points align, making it possible to simply include a single first expander lens 83b and facilitate space-saving and reduce cost. As described above, the plurality of laser diodes 81 are linearly disposed in the sub-scanning direction H, and thus the optical paths from the laser diodes 81 can be easily overlapped.

A reference line KL illustrated in FIG. 10 is a straight line extending in the sub-scanning direction H from a point of incidence of the beams LB incident on the polygon mirror 86. In the present embodiment, the first diode 81a and the second diode 81b are positioned above the reference line KL, and the third diode 81c and the fourth diode 81d are positioned below the reference line KL. More specifically, the first diode 81a and the second diode 81b are disposed at positions closer to the reference line KL than the third diode 81c and the fourth diode 81d, and the reference line KL passes between the second diode 81b and the third diode 81c.

Further, with regard to angles of incidence of the beams LB emitted from the first diode 81a to the fourth diode 81d to the polygon mirror 86 in the sub-scanning direction H (the angle between the beam LB and the reference line KL), the angle of incidence (first incident angle θ1) of the beam LB of the first diode 81a is smaller than the angle of incidence (fourth incident angle θ4) of the beam LB of the fourth diode 81d, and the angle of incidence (second incident angle θ2) of the beam LB of the second diode 81b is smaller than the angle of incidence (third incident angle θ3) of the beam LB of the third diode 81c. That is, the first diode 81a and the second diode 81b as well as the third diode 81c and the fourth diode 81d are disposed with the angles of incidence of the beams emitted from the plurality of laser diodes 81 on the polygon mirror 86 being asymmetric in the sub-scanning direction H. In this way, by arranging the plurality of laser diodes 81 asymmetrically, it is possible to prevent reflected light (return light) from the polygon mirror 86 from entering the laser diodes 81.

In the related art, in order to improve optical performance (beam size and the like), the laser diodes need to be arranged close to each other in the height direction Z, and thus the plurality of laser diodes are arranged side by side and obliquely inclined. However, in order to employ an overfill optical system in the optical scanning device, it is necessary to incorporate an expander lens that forms a wide beam into the incidence system.

Therefore, when the side-by-side arrangement of the plurality of laser diodes in the related art is adopted, the optical path lengths from each laser diode to the polygon mirror surface differ for each beam of each color, making it necessary to arrange an expander lens in beam optical path of each laser diode (four expander lenses) in order to achieve optical performance, resulting in an increase in cost. Further, when the beam optical paths of the respective laser diodes are made to overlap in the main scanning direction S, a reflection mirror or the like is required.

On the other hand, in a case in which the laser diodes are arranged in a straight line in the height direction as in the present embodiment, the optical path lengths from the respective laser diodes to the polygon mirror surface are equal, and only one expander lens needs to be provided, making it possible to reduce cost. Further, in the present embodiment, an overfill optical system may be adopted for the optical scanning device 1.

Note that the embodiments disclosed herein are illustrative in all respects and are not the basis for a limited interpretation. Accordingly, the technical scope of the disclosure is not to be construed by the foregoing embodiments only, and is defined based on the description of the claims. In addition, meanings equivalent to the range of the claims and all changes made within the range are included.

What is claimed is:

1. An optical scanning device that causes beams emitted from a plurality of light sources to be incident on a rotary polygon mirror, the optical scanning device comprising:
a first expander lens that expands the beams emitted from the plurality of light sources in a main scanning direction,
wherein the beams emitted from the plurality of light sources are incident on the first expander lens, the first expander lens being a single lens, and
the plurality of light sources are disposed with optical paths of the beams from the plurality of light sources to the rotary polygon mirror overlapping each other in the main scanning direction when viewed from a direction along a rotary shaft of the rotary polygon mirror.

2. The optical scanning device according to claim 1,
wherein the plurality of light sources are linearly disposed in a sub-scanning direction orthogonal to the main scanning direction.

3. The optical scanning device according to claim 1, comprising
a cylindrical lens that changes an incident angle with respect to the rotary polygon mirror in a sub-scanning direction orthogonal to the main scanning direction.

4. The optical scanning device according to claim 3,
wherein the cylindrical lens is integrated with the first expander lens.

5. The optical scanning device according to claim 3,
wherein the plurality of light sources are disposed with the incident angle of each of the beams emitted from the plurality of light sources on the rotary polygon mirror being asymmetric in the sub-scanning direction.

6. The optical scanning device according to claim 1,
wherein a second expander lens that collimates beams is disposed in an area from the first expander lens to the rotary polygon mirror in an optical path from the plurality of light sources to the rotary polygon mirror.

7. The optical scanning device according to claim 1, comprising
a housing to which the plurality of light sources are attached,
wherein the housing includes openings that narrow the beams emitted from the plurality of light sources.

8. An image forming device comprising:
the optical scanning device according to claim 1.
